(19) United States
(12) Patent Application Publication
(10) Pub. No.: US 2006/0260770 A1
(43) Pub. Date: Nov. 23, 2006

(54) Window roller blind with longitudinally-adjustable wind-up shaft

(75) Inventor: Jurgen Gradl, Wolfschlugen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: BOS GmbH & Co. KG, Ostfildern (DE)

(21) Appl. No.: 11/433,971

(22) Filed: May 15, 2006

(30) Foreign Application Priority Data
May 20, 2005 (DE) 102005023967.6

(51) Int. Cl. B60J 1/20

(52) U.S. Cl. 160/370.22

(57) ABSTRACT

A window roller blind assembly for motor vehicles which includes a roller blind affixed at one end to a wind-up shaft for extended and retracted movement with respect to a window of the motor vehicle. A bearing device is provided for the wind-up shaft that permits selective axial positioning of the wind-up shaft for enabling precise positioning of the roller blind with respect to the window with which the assembly is used.

### FIELD OF THE INVENTION

The present invention relates generally to window shades, and more particularly, to roller blind window assemblies for motor vehicles.

### BACKGROUND OF THE INVENTION

In four-door sedans, the rear side window of the rear side door is usually divided into an approximately rectangular section and into an approximately triangular section. Due to necessity, this division allows the largest part of the window panel located there to be moved up and down for the purposes of opening and closing. It is desirable that both areas be shaded with a window roller blind. For the approximately rectangular part, a window roller blind is used that moves vertically up and down, with the wind-up shaft of the roller blind being housed underneath the window sill.

The shading of the triangular part is effected with a roller blind whose outline is adapted to this area, wherein the wind-up shaft runs vertically and is arranged parallel to the guide rail that divides the window. The roller blind is activated, as is known in the art, for movement in a guide rail provided underneath the window sill. A pull element movably supported in the guide rail is attached to the tip of the roller blind.

Due to manufacturing tolerances in particular, the gap formed by the drawn-out roller blind of the triangular part with the window molding does not always have parallel edges. Due to the tolerances, the gap widens or narrows in the direction towards the wind-up shaft, which is generally considered unattractive.

### OBJECTS AND SUMMARY OF THE INVENTION

It is an object of the present invention to provide a motor vehicle roller blind that is adaptable for use on motor vehicle windows notwithstanding variations or tolerances in dimensions.

Another object is to provide a roller blind as characterized above which permits easy adjustment in the position of the roller blind relative to the window with which it is used for more effective utilization.

In carrying out the invention, the window roller blind has an attachment edge fixed to a wind-up shaft, which may be rotated for winding the roller blind onto the wind-up shaft. A bearing device is provided for selectively setting the axial position of the wind-up shaft. By adjusting the axial position, it is possible to adjust the remaining lower gap relative to the window sill for triangular side window roller blinds so that a parallel gap is produced.

The axial adjustment of the wind-up shaft also can be used to eliminate misalignment in the roller blind for roller blinds with rectangular outlines. For such roller blinds, as appear, for example, in the rear window area, the front edge of the roller blind, i.e., the edge that moves back and forth in front of the window, is rigidly connected to a tension rod. The effective length of the tension rod changes, starting from the retracted position, in which the rear window has its greatest width, in the direction towards the drawn-out position. At this position, the distance between the guide rails of the tension rod is smallest due to the window geometry. If the structural position of the tension rod relative to the wind-up shaft does not agree with the actual position due to car body tolerances, an unattractive diagonal misalignment in the roller blind is created. This diagonal misalignment can be eliminated if the wind-up shaft is adjusted in the axial direction. The attachment edge for the roller blind is preferably a straight edge, which creates easily reproducible relationships for the assembly or the attachment of the roller blind to the wind-up shaft.

Guide means are provided to guide the roller blind in the area between the retracted position and the drawn-out position. In the case of a triangular window roller blind, the guide means comprise a tension element that is attached to the tip of the roller blind blank. In the case of a rectangular roller blind, the tension element comprises a tension rod.

According to the configuration of the roller blind, the guide means include one or two guide rails, which are positioned opposite each other and between which the tension rod is guided. In each case, the guide rails include a guide groove with a groove chamber and a groove slit, wherein the open width of the groove slit is smaller than the open width of the groove chamber. The groove chamber is further used for buckle-proof guidance of a linear push element, which is preferably positively driven by means of a geared motor.

The bearing device includes a cylindrical peg on which the wind-up shaft can rotate. The mounting of the wind-up shaft on the peg also can be designed so that the wind-up shaft can execute a translational movement on the peg.

If the peg has a shoulder used as an axial bearing, the axial position of the wind-up shaft can be adjusted by shifting the peg or the shoulder. To guarantee the adjustment in a simple way or to ensure contact on the pressure bearing surface, the spring motor is preferably provided with a spring designed so that the wind-up shaft is held with its end contacting the pressure bearing surface.

The bearing device also can include a bearing bushing with a bearing bore hole. The bushing can be used to support the wind-up shaft at one end so that it can rotate. A holder, with whose help the bushing is adjustable in the axial direction, is assigned to the bushing in order to set the axial position of the wind-up shaft. To set the bushing, it can be provided with external threads that screw into internal threads of the holder. By turning the bushing, the axial position of the bushing can be adjusted.

An activation element preferably is associated with the bushing. The activation element can be formed, for example, by a star wheel. So that the bushing is not adjusted when the wind-up shaft is activated, a locking device is associated with the bushing, for example, in the shape of a catch device, of which one part can be formed, for example, by the star-shaped wheel.

Other objects and advantages of the invention will become apparent upon reading the following detailed description and upon reference to the drawings, in which:

### BRIEF DESCRIPTION OF THE DRAWINGS

FIG. 1 is a broken open perspective of a rear area of a motor vehicle having a window shade in accordance with the invention;

FIG. 2 is an enlarged fragmentary section of the rear side windows and roller blind assembly according to the invention;

FIG. 3 is an enlarged longitudinal section of the wind-up shaft and its axially adjustable support bushing for use with the triangular configured roller blind shown in FIG. 2;

FIG. 4 is an alternative embodiment of wind-up shaft an axially adjustable support bushing for the roller blind shown in FIG. 2; and

FIG. 5 is a schematic depiction of a generally rectangular rear window window shade according to the invention.

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DETAILED DESCRIPTION OF THE PREFERRED EMBODIMENTS

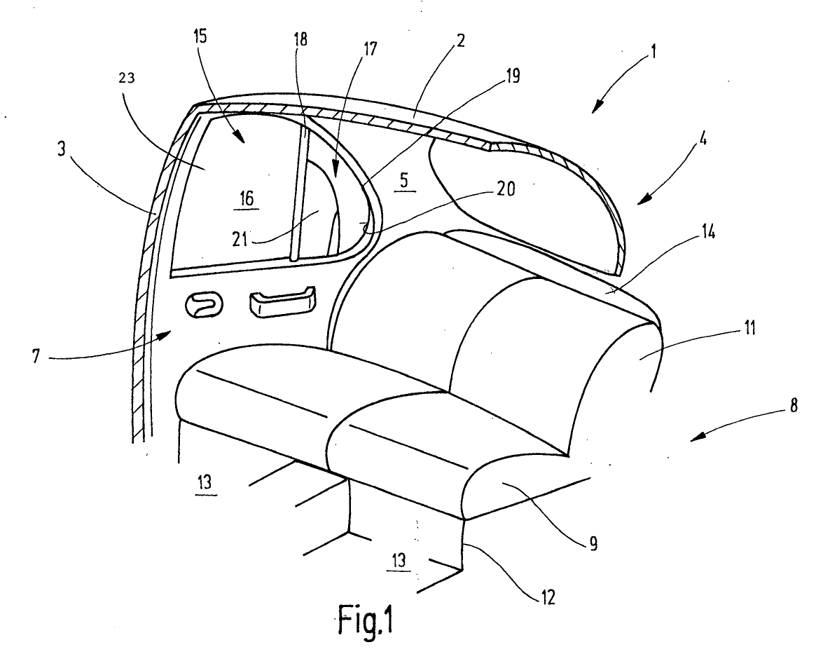

Referring now more particularly to FIG. 1 of the drawings, there is shown an illustrative motor vehicle having a rear window roller blind assembly in accordance with the invention. FIG. 1 represents a cut-away rear area of a passenger car. The figure illustrates a view towards the right-side interior, which is the mirror image of the not-shown left-side interior. The view is simplified; for example, car body interior structures such as braces and attachment means are not shown because their illustration is not necessary for understanding the invention.

The illustrated car body section 1 has a roof 2 from which a B-column 3 extends downwardly at the side to a floor pan. A corresponding B-column is provided on the opposite side of the vehicle. The roof 2 transitions at its rear edge into a rear window 4. At the side, the rear window 4 ends at a C-column 5 located at a distance from the B-column 3. The C-column 5 carries an interior lining.

Between the B-column and the C-column, a rear right side door 7 is hinged in a known way to the B-column. At the height of the right rear side door 7 there is a rear seat bench 8 which includes a sitting surface 9 and also a rear seat back 11. The rear seat back 9 is supported on a base surface 12 in front of which are footwells 13. At the height of the top edge of the rear seat back 11, a rear seat shelf 14 extends to the bottom edge of the rear window 4.

The right rear side door 7 is provided with a side window 15 typical for sedans. The side window 15 is divided into a first window section 16 and also into a rear, second window section 17. The first window section 16 has an essentially rectangular shape and is bounded at the rear by a guide column 18 that at the same time represents an edge of the second window section 17. The second window section 17 is bounded opposite the guide column 18 by a window frame 19, which, together with the guide column 18, establishes the shape of the second window section 17. It is, as shown, approximately triangular, with a border that has a strong curvature at 20 that lies opposite to the guide column 18. The guide rail 18 has a guide groove 22 of a known type for guiding movement of the side window 23. Another corresponding groove is located on the opposite side of the window section 15.

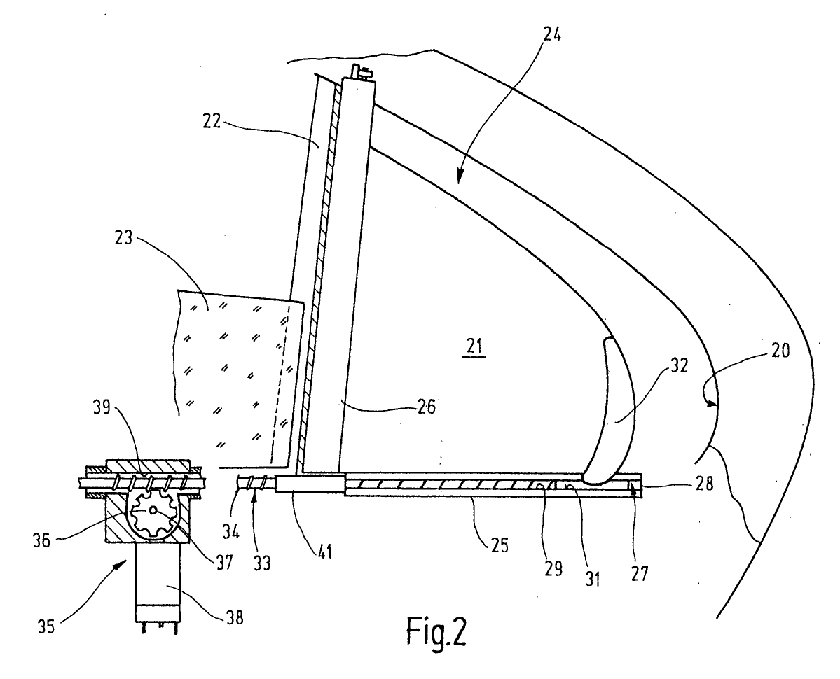

A roller blind is provided for both window sections 16, 17 as depicted in FIG. 1, with part of a roller blind 21 for the window section 17 being shown in the drawing. The roller blind 21 is part of a side window roller blind assembly 24, as best seen in FIG. 2. The roller blind 21 in this instance has approximately triangular configuration, with its shape corresponding approximately to the shape of the rear window section 17. A guide rail 25 of the side window roller blind assembly 24 is disposed adjacent a bottom of the window section 17. A roller blind housing 26 is arranged parallel to the guide rail 18 and can be combined with this rail, for example, into one unit.

The guide rail 25 extends approximately at a right angle to the housing 26 and contains a guide groove 27 whose cross section is composed from a groove chamber 28 and a groove slot 29 whose open width is smaller than that corresponding to the diameter of the groove chamber 28. The groove slot 29 opens in the direction towards the interior of the vehicle. A guide piece 31, to which a fin-like contoured part 32 is attached via a reduced thickness throat, runs in the groove chamber. As shown, the contoured part 32 is attached rigidly to the tip end of the roller blind outline 21, for example, through adhesion.

For drawing out the roller blind 21, a flexible, linear push element 33 is provided that has the shape of a flexible toothed rack with inclined teeth extending in a helical pattern around a core 34. The outer diameter of the linear push element corresponds to the width of the groove chamber 28.

The push element 33 is driven by a gear motor 35, which drives an output gear 36 fixed on a drive output shaft 37, via a reduction gear. The gear motor 35 preferably is a permanently-excited DC motor 38.

The teeth of the output gear 36 are shaped so that they can mesh with a positive fit with the teeth of the push element 33. For this purpose, the gear housing of the geared motor 35 is formed with a continuous guide bore hole 39 that passes tangentially by the output gear 36. A guide tube 41, which connects the gear motor to the end of the guide rail 25 adjacent to the housing 26, is aligned with the guide bore hole 39 in order to guide the push element 33 in this region in a buckle-resistant fashion.

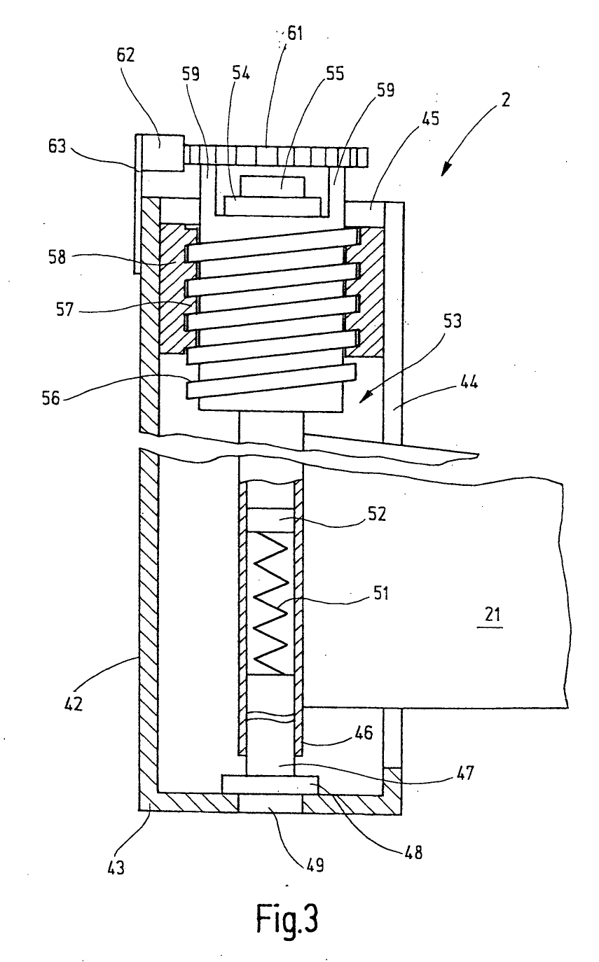

The roller blind housing 26, as depicted in FIG. 3, has a cup shape with an internally cylindrical side wall arrangement 42 and a housing base. To permit passage of the roller blind 21, the side wall arrangement has a slot 44 that extends nearly to the base 43. The slot 44 extends up to a cylinder housing opening 45 located at the top. In the interior of the roller blind housing 26, a wind-up shaft 46 is rotatably mounted. The wind-up shaft 46 is tubular and the roller blind 21 is fixed at a peripheral side in a known manner.

The bottom end of the wind-up shaft 46, as also shown in FIG. 3, is rotatably supported on a stationary, non-rotatable cylindrical peg 47. The peg 47 has a bottom collar 48, which connects to a projection 49 anchored in a bore hole in the housing base 43. By virtue of the peg 47, the end of the wind-up shaft 46 is supported for both rotatable and axial movement. The peg 47 further acts an abutment for a helical spring 51, which serves as a spring motor and whose other end is fixed via a connection piece 52 to the wind-up shaft 46. The helical spring 51 simultaneously acts to bias the wind-up shaft 46 in a direction against the collar 48.

The bearing peg 46 has a length dimensioned so that the peg 47 remains engaged with the wind-up shaft 46 over the entire axial displacement stroke of the wind-up shaft 46. The top end of the wind-up shaft 46 is supported for rotation in a bearing bushing 53. The bearing bushing 53 in this case has a coaxial through hole in which the cylindrical wind-up shaft 46 is received for relative rotation. At the upper end, the wind-up shaft 46 has a stop plate 54 that is held in tight contact against the end of the wind-up shaft 46 by means of a screw 55 secured in the end of the wind-up shaft 46. As can be seen in FIG. 3, the stop plate 54 is located opposite the top end side of the bearing bushing 53 in contact with the bushing.

The bearing bushing 53 has a peripheral section formed with threads 56, which receive nut threads 57 formed in a cylindrical insert 58 which is fixed in the side wall arrangement 52 close to the housing opening 45. The insert 58 may be secured, for example, to the housing 26.

Several columns 59, to which a star-shaped plate 61 is fixed, project upwardly from the top end of the bearing bushing 53. The star-shaped plate 51 in this instance is formed as a ring in order to be able to insert the stop plate 54 through the ring. As can be seen, the star-shaped plate 51 is arranged concentric to the longitudinal axis of the bearing bushing 53, and this, in turn, is concentric or coaxial to the wind-up shaft 46. The star wheel 61 acts, together with a catch element 62, as a catch device in order to prevent undesired rotation of the star wheel 61. The catch element 62 sits on a leaf spring 63 anchored on the outer side of the housing 26.

The function of the side window roller blind 24 is as follows:

By means of the helical spring 51 acting as a spring motor, the wind-up shaft 46 is biased in a direction for winding up the roller blind 25 onto the wind-up shaft 46. If no forces act on the roller blind or the contoured part 32, the roller blind 21 is wound onto the wind-up shaft 46 and stowed in the roller blind housing 26. To draw out the roller blind 21 in front of the window section 17, the geared motor 35 is set in motion in the appropriate rotational direction. The output gear 36, which meshes with a positive fit with the teeth of the push element 33, moves the push element 33 in the direction towards the guide rail 25. Here, the free end of the push element 33 engages with the guide piece 31 and pushes the guide piece 31 in front of it. Because the guide piece 31 is coupled to the tip end of the roller blind 21 via the contoured part 32, which acts as a tensioning element, the roller blind 21 is drawn away from the wind-up shaft 46 against the tensile force of the helical spring 51 and spread out in front of the window section 17. The movement stops when the contoured part 32 comes to the tip end 20 of the window section 17.

The wind-up shaft 46 is supported, on the one hand, on the peg 47 so that it can rotate during the movement of the blind, and on the other hand, in the bore hole of the bearing bushing 53. The vertical position is defined by the top end of the bearing bushing 53 against which the stop plate 54 bears. The stop plate 54 is urged in that position by the biasing force of the helical spring 51, which is designed to pull the wind-up shaft 56 downwards.

For a drawn-out roller blind, if the bottom edge of the roller blind 21 does not run parallel to the adjacent window edge, the height of the wind-up shaft 46 can be adjusted until the desired parallel arrangement is achieved. For this purpose, the bearing bushing 53 is turned in the appropriate direction by means of the star wheel 61. Due to the threaded connection of the bearing bushing 53 with the insert 58, when the bearing bushing 53 rotates, the bushing moves according to the rotational direction in the axial direction upwards or downwards, in the direction away from the peg 47 or towards this peg. This axial displacement is transferred via the stop plate 54 to the wind-up shaft 46, which is shifted accordingly in the axial direction. In each axial setting, the tension of the helical spring 51 ensures that the stop plate 54 remains in contact with the top end of the bearing bushing 53. The collar 48 is designed to be far enough away to not limit the displacement stroke.

A catch 62 is provided so that the desired depth setting of the bearing bushing 53 in the insert 58 will not shift. The catch 62 engages in the teeth of the star wheel 61 and prevents the star wheel 61 from rotating accordingly. Due to the rotationally locked connection to the bearing bushing 53, the latter is also prevented from rotating. It can be seen that in the illustrated arrangement that during axial positioning of the wind-up shaft 46, the wind-up shaft is pulled downwardly under the force of the helical tension spring 51.

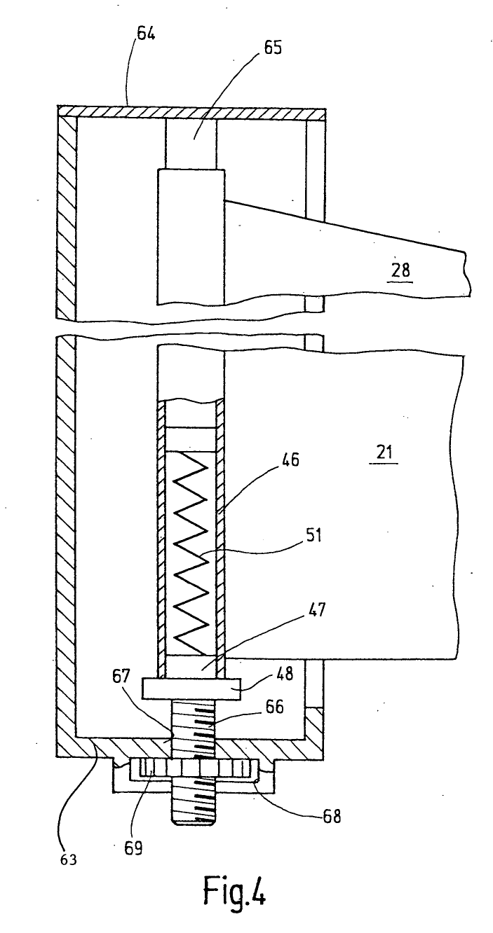

With reference to FIG. 4, an alternative embodiment of axial bushing support is shown wherein axial adjustment is performed with the assistance of a pressure device. Parts similar to those described above have been given similar reference numerals.

In the arrangement from FIG. 4, a cover 64, which carries a bearing peg 65 pointing downwardly, is seated an the upper opening of the housing. The bearing peg 65 projects into the wind-up shaft 46 so that it can both rotate and move in the axial direction. The bearing peg 65 is dimensioned long enough that the peg 65 remains engaged with the wind-up shaft 46 over the entire axial displacement stroke of the wind-up shaft 46.

A bottom bearing peg 47, similar to the bearing peg 47 shown in FIG. 3, is shorter, because there is no necessity that the wind-up shaft 46 move relative to this peg in the longitudinal direction. The wind-up shaft 46 contacts the collar 48 which serves as an axial bearing at its bottom end. Underneath the collar 48 is a threaded projection 66 which, as viewed over its length, is flattened on its sides so that two opposite and parallel flat sides are created.

A through hole 67 contained in the base 63 is adapted in contour to the cross section of the threaded peg 66. In this way, the threaded peg 66 is to moveable in the opening 67 only in the axial direction, but cannot rotate. On the bottom side of the base 63 is a pocket 68 that is open towards the viewer and receives a flat threaded nut 69. The pocket 68 fixes the threaded nut 69 in the axial direction. On the other hand, the nut 69 can rotate freely in the pocket 68.

The axial adjustment of the wind-up shaft 46 in this case is as follows:

By rotating the nut 69, the rotationally locked threaded projection 66 fixed in the housing floor 63 can be shifted in the axial direction. The axial displacement is transferred to the wind-up shaft 46 via the stop collar 48. The wind-up shaft 46, as before, is held in contact against the stop collar 48 by the helical spring 61 acting as a spring motor. The upper end of the wind-up shaft 46 can thereby be moved axially on the bearing peg 65 for the height adjustment.

Because the threaded projection 66 is rotatably locked in the opening 67, the threaded projection 66 simultaneously acts as a stationary anchor point for the helical spring 51 so it is in condition to exert a force on the wind-up shaft in the wind-up direction. To maintain the setting of the wind-up shaft, a similar catch locking device can be used with the nut 69 as explained in connection with the embodiment of FIG. 3.

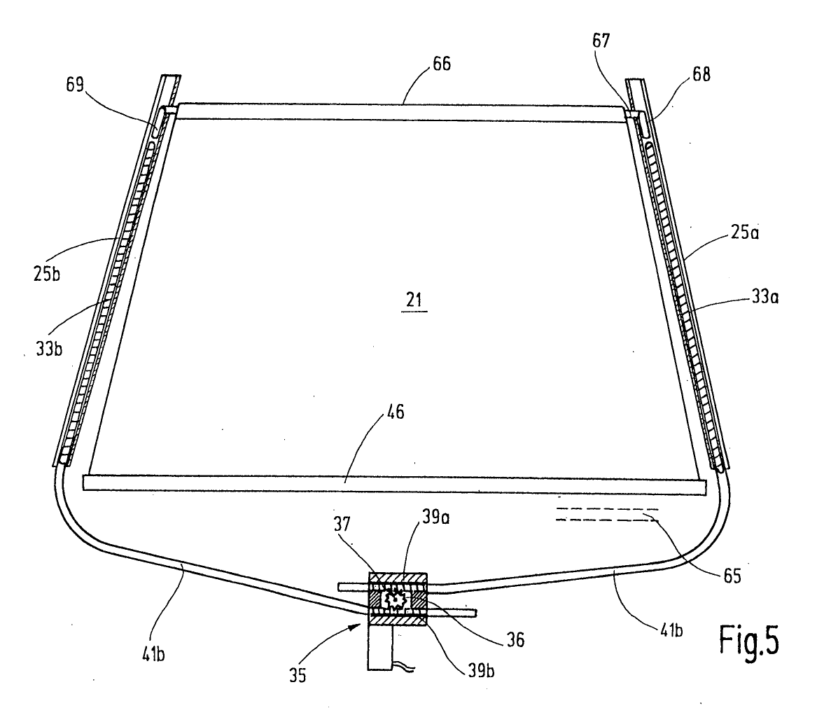

The axially adjustable wind-up shaft described above has been shown in connection with the window roller blind 24 for the triangular window section 17. The axial adjustment can also be used in connection with an essentially rectangular section 16, wherein the layout for the support of the wind-up shaft is the same as explained in connection with FIGS. 3 and 4. Such an arrangement is shown in FIG. 5, wherein some of the parts corresponding to those previously described have similar reference numerals with the distinguishing suffix “a” added.

The wind-up shaft 46 is supported at its ends in the embodiment of FIG. 5 similar to that shown in FIGS. 3 and 4. However, one difference can be that the end supports are not stored in a housing, but instead on a support frame 65 shown with dashed lines in FIG. 5.

The roller blind 21 corresponds to the shape of the window to be shaded. The roller blind is fixed by one edge, as described, to the wind-up shaft 46, for example, by means of weatherstripping or adhesive. The edge away from the wind-up shaft 46 is positioned in a hanger or loop 66 of the wind-up blind 21. A tension rod 67 may be guided through the hanger, which is provided at both ends with telescoping displaceable guide elements 68, 69.

In the embodiment from FIG. 5, there are two guide rails 25a, 25b for guiding movement the tension rod 67 in a common plane. Their shape corresponds to the configuration as explained in connection with FIG. 2, but with the difference that the groove slots open in the direction towards each other. The push elements 33a and 33b again move in the groove chambers. The bottom ends of the two guide rails 25a, 25b are connected to a geared motor 35 via guide tubes 41a, 41b. The geared motor 35 contains in its gear housing two guide bore holes 39a, 39b that pass the output gear 36 tangentially on opposite sides. By setting the geared motor 35 in motion, the two push elements 33a, 33b are shifted forward or retracted in the guide rails 25a, 25b, in sync with the same stroke. When shifted forward, the guide pieces 68, 69 running in the groove chambers move forward, wherein the front edge of the roller blind 24 moves forward and in this way the roller blind 21 is placed in front of the window.

In order to equalize alignment errors or lateral offset between the tension rod 67 in the upper end position and the axial position of the wind-up shaft 46, the shaft can be shifted slightly in the axial direction, as explained in detail with reference to FIGS. 3 and 4, so that no inclined folds appear in the roller blind 21.

From the foregoing, it can be seen that the motor vehicle window roller blind assembly according to the invention has a bearing device for the wind-up shaft that enables the axial position of the wind-up shaft to be adjusted when mounted, thereby enabling selective positioning of the blind with respect to the window with which it is used.

1. A window roller blind assembly (24) for motor vehicles comprising:
a roller blind (21) having an attachment edge at one end,
a wind-up shaft (46) to which the attachment edge of the roller blind (21) is affixed,
a drive device (35, 51), for rotating the wind-up shaft (46) in a wind-up direction for winding the roller blind (21) onto the wind-up shaft (46),
a bearing device (47, 53, 65) for rotatably supporting the wind-up shaft, and
said bearing device (47, 53, 65) having an adjustment device (53, 66) for selectively adjusting an axial position of said wind-up shaft (46) for selectively positioning the roller blind (21) with respect to a window with which the wind-up roller assembly (24) is used.

2. The roller blind assembly of claim 1 in which said roller blind (21) has a generally triangular shape.

3. The roller blind assembly of claim 1 in which the attachment edge of the roller blind (21) is a straight edge.

4. The roller blind assembly of claim 1 including at least one guide mechanism associated with the roller blind (21) for guiding movement of the roller blind between extended and retracted positions relative to the wind-up shaft.

5. The roller blind assembly of claim 4 in which said guiding mechanism includes a tensioning element (32) attached to the roller blind (21) for drawing the roller blind (21) from the wind-up shaft.

6. The roller blind assembly of claim 5 in which said tensioning element (32) is provided at a point on the roller blind farthest removed from the said wind-up shaft.

7. The roller blind assembly of claim 5 in which the tensioning element is a rod (67) that extends parallel to the wind-up shaft (46).

8. The roller blind assembly of claim 4 in which the guide mechanism includes at least one guide rail (25) for guiding movement of the tensioning element (32).

9. The roller blind assembly of claim 8 in which the guide rail 25 has a guide grove 27 defined by a groove chamber 28 and a groove slot 29, with the width of the groove chamber (28) being greater than the opening width of the guide slot (29).

10. The roller blind assembly of claim 9 including two said guide rails (25) having guide grooves (29) that lie in a common plane and open in a direction toward each other.

11. The roller blind assembly of claim 1 in which the drive device (35, 51) includes a spring motor (35) coupled to said wind-up shaft (46).

12. The roller blind assembly of claim 5 in which said drive device (35, 51) includes a gear motor (35) coupled to said tensioning element (32) of said roller blind (21) by at least one linear push element (33).

13. The roller blind assembly of claim 12 in which said push element (33) is moveable in a passageway for buckle resistant movement between the gear motor (35) and the guide rail (25).

14. The roller blind assembly of claim 1 in which said bearing device (47, 53, 65) includes a cylindrical peg (47, 65) at one end of said wind-up shaft upon which the wind-up shaft is supported for relative rotational movement.

15. The roller blind assembly of claim 14 in which said wind-up shaft (47) is axially moveable relative to said support peg (47, 65).

16. The roller blind assembly of claim 15 in which said peg (47) has a collar (48) for supporting said one end of said wind-up shaft (46).

17. The roller blind assembly of claim 16 in which said collar (48) is adjustably positionable in an axial direction of the wind-up shaft.

18. The roller blind assembly of claim 17 including a spring motor having a spring (51) for maintaining the wind-up shaft (46) in contact with said collar (48).

19. The roller blind assembly of claim 18 in which said collar (48) is formed in one piece with said peg, and said peg is adjustably positionable in an axial direction of the wind-up shaft.

20. The roller blind assembly of claim 1 in which said bearing device includes a bearing bushing (47).

21. The roller blind assembly of claim 20 in which said wind-up shaft (46) is rotatably supported in said bearing bushing (47).

22. The roller blind assembly of claim 20 in which said bearing bushing (47) is adjustably positionable in an axial direction of the wind-up shaft.

23. The roller blind assembly of claim 20 in which said bearing bushing (47) includes a holder (48) which is adjustable in an axial direction with the bearing bushing (47).

24. The roller blind assembly of claim 20 in which said wind-up shaft (46) includes a collar (54).

25. The roller blind assembly of claim 24 in which said collar (54) bears against one end of said bearing bushing (47).

26. The roller blind assembly of claim 24 in which said collar (54) contacts an end of the bearing bushing (54).

27. The roller blind assembly of claim 20 in which the bearing bushing (53) includes a threaded section.

28. The roller blind assembly of claim 20 including an actuator (61) for adjusting the position of said bearing bushing (53).

29. The roller blind assembly of claim 28 in which said actuator (61) includes a star-shaped wheel.

30. The roller blind assembly of claim 20 including a locking device for locking said bearing bushing in a predetermined axially adjusted position.

31. The roller blind assembly of claim 30 in which said locking device (62) is a catch device.

32. The roller blind assembly of claim 32 in which said catch device includes a catch (62) that is cooperable with said star shaped wheel (61).

33. The roller blind assembly of claim 1 including a housing (26) in which said wind-up shaft (46) is disposed.
